(19) United States
(12) Patent Application Publication
(10) Pub. No.: US 2009/0321225 A1
(43) Pub. Date: Dec. 31, 2009

(54) APPARATUS FOR TRANSPORTING CONTAINERS

(75) Inventors: Paolo Tacchini, San Martino di Monte San Pietro (IT); Maurizio Bonarelli, Zola Predosa (IT)

Correspondence Address: NIXON & VANDERHYE, PC, 901 NORTH GLEBE ROAD, 11TH FLOOR, ARLINGTON, VA, 22203, US

(73) Assignee: A-PACK TECHNOLOGIES SA, Courroux (CH)

(21) Appl. No.: 12/297,195

(22) PCT Filed: Apr. 13, 2007
(86) PCT No.: PCT/IB07/00964

§ 371 Date: Feb. 19, 2009

(30) Foreign Application Priority Data
Apr. 13, 2006 (IT) BO2006A000278

(51) Int. Cl. B65G 15/58

(52) U.S. Cl. 198/867.02

(57) ABSTRACT

An apparatus for conveying containers comprising a belt moved by a pulley arrangement along a longitudinal direction of advancement, and supporting elements of the containers associable with the belt by means of connecting elements fixed to the belt, each connecting element comprising a coupling arrangement for engaging and blocking a respective supporting element and a driving arrangement, suitable for engaging a holding arrangement of the pulley arrangement for moving the belt; an apparatus for conveying containers comprising a belt, looped around a pulley arrangement and suitable for moving the containers in a longitudinal direction of advancement, a moving arrangement for driving the pulley arrangement, and a positioning arrangement configured for supporting and moving the pulley arrangement and the moving arrangement along a transverse direction of adjustment.

### CROSS-REFERENCE TO RELATED APPLICATIONS

This application is the U.S. national phase of International Application No. PCT/IB2007/000964, filed 13 Apr. 2007, which designated the U.S and claims priority to Italy Application No. B02006A000278, filed 13 Apr. 2006, the entire contents of each application is hereby incorporated by reference.

### DESCRIPTION

The invention relates to a conveyor apparatus, specifically, an apparatus suitable for moving containers such as bottles, vials, carpules, syringes and similar in an automatic packaging machine used for pharmaceutical and/or cosmetic and/or food products.

The conveyor apparatuses are configured for transferring containers to be packed through a series of operating stations of a packaging machine at which a plurality of operations are carried out on containers, such as, filling with a product, weighing, closure, etc.

The known conveyor apparatuses typically comprise a conveyor belt, closed in a loop around a drive pulley and an idle pulley and provided with driving elements or housing seats for said containers.

The conveyor belt comprises an upper moving branch and a lower return branch and is moved in a longitudinal driving direction by the drive pulley, which is placed at the end downline of the upper branch.

Especially in the pharmaceutical field, metal conveyor belts, typically made of stainless steel with smooth polished surface, are used, which are particularly suitable in the packaging processes where products are to be handled in aseptic or sterile environments to avoid particle or microbiological contamination. The metal conveyor belts can, in fact, be washed and sterilized effectively during the periodic cleaning operations.

Movement of the conveyor belt is generally brought about by means of a drive pulley provided with teeth, typically cylindrical pins, suitable for engaging in the respective holes made in the belt.

The driving is sometimes done also owing to the friction created between the outer edge of the pulley and the inner surface of the metal conveyor belt.

The meshing between the pulley and the belt makes it possible to refer the angular position of the pulley with the linear position of the belt and thereby maintain a step relation between the containers and the operating stations.

One significant problem encountered in this type of conveyor apparatuses is the possible, gradual escape of the pulley pins from the respective holes in the belt, because of the difference in dimensions between the pitch of the pins and that of the holes, as well as because of the incorrect belt tension.

The escape of the pins, even partial, causes a sliding of the belt on the pulley and consequently phase shifts or variations of the position of the containers conveyed with respect to the machine's operating stations.

In addition to this, the escape of the pins causes abnormal stresses of considerable intensity both on the pins as well as on the holes, such as to lead to localised deformations and/or breakage.

The presence of through holes on the metal conveyor belt is also not very suitable in applications that require the installation of the conveyor apparatus in aseptic/sterile environments, especially in packaging of pharmaceutical products. For example, if the conveyor apparatus is inserted in a dosing machine for liquid pharmaceutical products, if the latter spill and accidentally spread on the outer surface of the conveyor belt, the presence of holes on it will allow the passage and spreading to the internal part of the conveyor belt, thereby dirtying a plurality of organs and elements of the conveyor apparatus, such as pulleys, guides, etc. In this case, long and complicated washing and sanitization and/or sterilization operations will have to be carried out, which may also require dismantling of the components and organs of the apparatus.

Certain types of conveyor apparatuses comprise one or more flat surfaces on which the containers rest and slide, drawn into motion by suitable projecting elements of the conveyor belt. Said elements, generally in the form of prongs or teeth, are equidistant from one another in such a way as to form compartments inside which the containers to be handled are inserted. One or more longitudinal abutting guides maintain the containers inside the compartments during the movement.

In certain applications, the compartments are made directly on the conveyor belt and have a divergent V-shape in the direction of the longitudinal abutting guide for housing and moving containers of different sizes.

The rubbing of containers on these supporting surfaces may, however, lead to certain problems like the generation of particles of material of the containers or of the surfaces which can contaminate the product to be packed; the generation of static electricity charges which can alter the correct working of the electric or electronic devices present in the packaging machine; the need for a considerably powerful drive unit to overcome the friction caused by rubbing of a large number of containers.

To overcome these problems, in certain conveyor apparatuses the containers are placed directly on the belt, supported laterally and at the back by suitable containment elements and frontally by one or more longitudinal abutting guides. Alternatively, conveyor belts are also known, provided with supporting elements, commonly referred to as “godet”, having seats with divergent containment walls to house containers of different shapes, in collaboration with a longitudinal abutting guide.

The supporting elements are removably connected to the conveyor belt by means of suitable coupling devices in such a way as to be rapidly assembled and/or disassembled from the belt, for example, in case of washing and sanitization of the conveyor apparatus and/or in case of their replacement for size change of the containers.

Said coupling devices may comprise shaped pins solidly connected to said supporting elements and suitable for engaging in corresponding through holes or slots made on the belt. These devices allow easy and rapid assembly and disassembly of the supporting elements, but the presence of openings on the belt is hardly suitable as already disclosed and explained above.

Fixing devices are also known, comprising fixing blocks fixed to the belt and provided with guides for removable and slidable coupling to respective supporting elements. These fixing blocks prevent the product to be packed from passing into the internal part of the belt; however, because of their shape and configuration, they must be disassembled, like the supporting elements, to be washed and sanitized effectively. This involves an increase in machine stop times necessary for disassembling the blocks and preparing the apparatus for periodic cleaning and sanitization operations.

In order to transfer containers of different shapes, apart from having receiving seats of adaptable shape, the known conveyor apparatuses have an adjusting arrangement capable of changing the relative position of the belt and the longitudinal abutting guides.

In known packaging machines, in particular in dosing machines, a fixed vertical reference plane is defined, in relation with which the operating stations are aligned and in relation to which the mouths of the containers must be necessarily aligned. With change in the dimensions of the latter, it, therefore, becomes necessary to adjust the position in relation to said vertical reference plane, i.e. to adjust the position of the conveyor apparatus in a transverse direction in relation to the longitudinal direction of advancement of the belt.

In known conveyor apparatuses, these adjustments are made manually by specialist technicians, who shift the guide or the longitudinal abutting guides, the drive pulleys of the metal belt, the frame and the supporting guides of the latter. These adjustments, in addition to requiring specialist labour, need long shutdowns of the apparatus and the packaging machine, with resulting interruption and reduction of production.

The transverse adjustment of the drive pulleys is done using suitable slidable couplings associated with supporting shafts of said pulleys. In particular, in case of drive pulley, suitable transmission organs allow the corresponding supporting shaft, which is connected to the machine's drive unit, to rotate and at the same time slide axially.

These transmission organs have the disadvantage of introducing plays and inaccuracies in the movement of the belt and consequently, in the positioning of the containers conveyed by the belt at the operating stations. The entity of these plays and inaccuracies may be variable, depending on the transverse position of the belt and/or wear and tear of the transmission organs.

An object of this invention is to improve the known conveyor apparatuses for containers, in particular, by increasing the flexibility of use, the reliability and the precision of movement of containers.

Another object is to obtain a conveyor apparatus capable of moving the containers in a precise and accurate manner, ensuring the absence of skidding between the conveyor belt and pulleys, i.e. maintaining the correct step ratio between the latter. A further object is to obtain a conveyor apparatus which makes it possible to hook on to and release the containers supporting elements from the conveyor belt rapidly, easily and reliably.

A still further object is to make a conveyor apparatus which ensures the maximum stability of containers during their movement, independently of their size. Another object is to make a conveyor apparatus which can be cleaned and sanitized easily and efficiently, in compliance with the standards and regulations regarding packaging of pharmaceutical products in an aseptic and/or sterile environment.

A further object is to obtain a conveyor apparatus which makes it possible to carry out the adjustment operations for container size change automatically.

A still further object is to obtain a conveyor apparatus which ensures a transmission of movement to containers almost free of plays and inaccuracies.

In a first aspect of the invention, a containers conveyor apparatus is provided comprising a belt closed in a loop around a pulley arrangement suitable for moving said belt in a longitudinal direction of advancement, and supporting elements prearranged for receiving and housing said containers and removably associated, in a coupling condition, with said metal belt by means of connecting elements fixed to said belt wherein each connecting element comprises a coupling arrangement suitable for coupling with a respective supporting element, and a driving arrangement, suitable for engaging a corresponding holding arrangement of said pulley arrangement for moving said belt.

Owing to this aspect of the invention, it is possible to obtain a conveyor apparatus capable of moving the containers in a precise accurate manner, maintaining the step ratio between the pulley arrangement and the belt.

Since each connecting element comprises a coupling arrangement and a driving arrangement, the position of the corresponding supporting element and thereby of the container conveyed is defined precisely and clearly in relation to belt. In fact, there is no need for separate seats for fixing the coupling arrangement and the driving arrangement on the latter, as such separation can introduce positioning errors.

The coupling between the driving arrangement and the holding arrangement ensures a correct step reference between the belt and the drive pulley during the working and prevents relative slipping and sliding between the latter. The shape of the driving arrangement and holding arrangement allows a regular meshing at each step as well as the recovery of phase displacement or sliding, if any.

The coupling arrangement of the connecting elements further make it possible to hook and unhook the supporting elements of the containers on the conveyor belt in a rapid, easy and reliable manner, to allow easy size change operations and effective washing and cleaning operations.

Owing to the structure and shape of belt and connecting elements the apparatus can be cleaned and sanitized easily and efficiently.

In a second aspect of the invention an apparatus for conveying containers is provided, comprising a belt closed in a loop around a pulley arrangement and suitable for moving a plurality of said containers in a longitudinal direction of advancement and comprising a moving arrangement for setting in rotation said pulley arrangement, wherein it further comprises a positioning arrangement configured for supporting and moving said pulley arrangement and said moving arrangement along a transverse direction of adjustment.

Owing to this aspect of the invention, it is possible to obtain a conveyor apparatus which has a transmission of motion of belt that is almost free of plays and inaccuracies. The positioning arrangement, in fact, make it possible to move the moving arrangement, comprising a motor and drive shaft for the connection to pulley arrangement, in order to carry out size change operations. This solution avoids the use of sliding joints or couplings, which are, however, necessary for bringing about simultaneous translation or rotation of the shaft in case of fixed moving arrangement.

In a third aspect of the invention, an apparatus for conveying containers is provided comprising a belt closed in a loop around a drive pulley and a driven pulley, said belt being suitable for moving said containers along a longitudinal direction of advancement, wherein it comprises a tensioning arrangement suitable for changing the distance between said drive pulley and said driven pulley along said direction of advancement for adjusting the tension of said belt.

Owing to this aspect of the invention, it is possible to make a conveyor apparatus that is capable of moving the containers in a precise accurate manner.

The tensioning arrangement make it possible to maintain the belt constantly in tension, with a pre-fixed tensioning force, thereby ensuring optimum meshing between pulleys and belt and preventing slipping between the latter.

The tensioning arrangement also makes it possible to adjust the aforementioned tensioning force easily and quickly according to the specific requirements, for example, number and dimensions of containers, sliding speed, etc.

The invention will be better understood and carried into effect with reference to the attached drawings, in which an embodiment is shown by way of non-limiting example, in which:

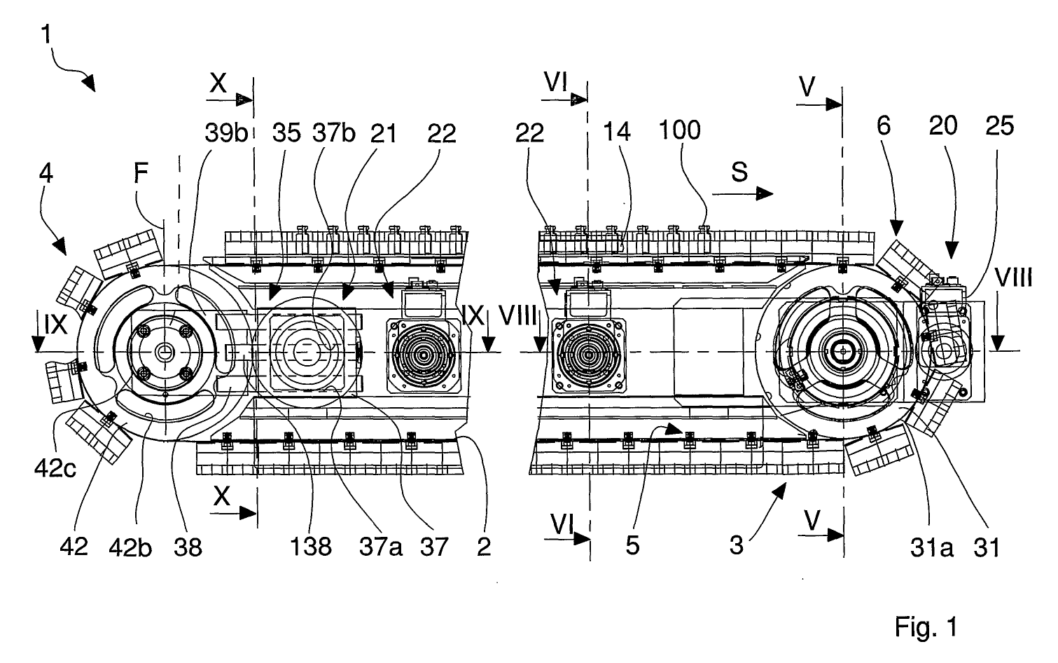

FIG. 1 is a partial front view of the conveyor apparatus for containers according to the invention;

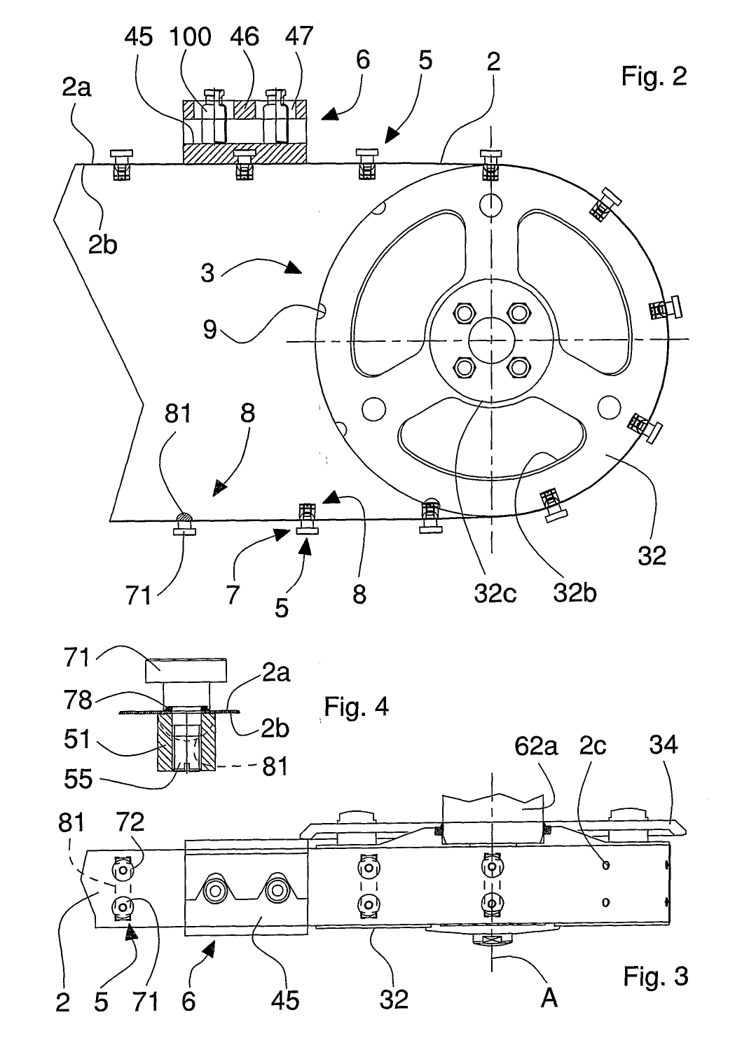

FIG. 2 is a partial and enlarged schematic front view of the apparatus in FIG. 1, showing a drive pulley arrangement and a belt, some parts having been removed for a better view of other parts;

FIG. 3 is a schematic top view of the apparatus in FIG. 2;

FIG. 4 is an enlarged detail of FIG. 2, showing a connection element fixed to belt;

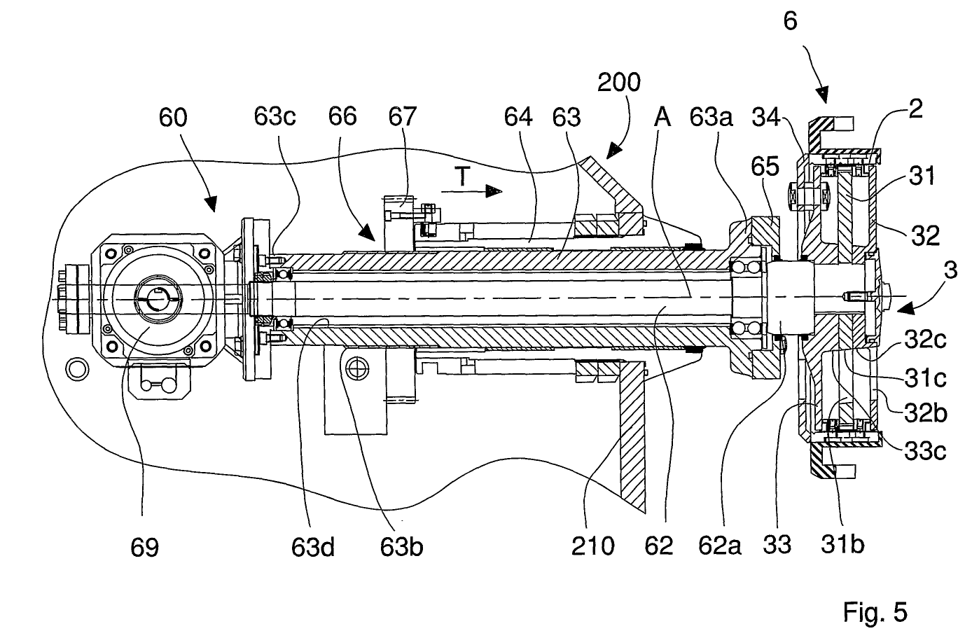

FIG. 5 is a partial cross-section according to a plane V-V of FIG. 1;

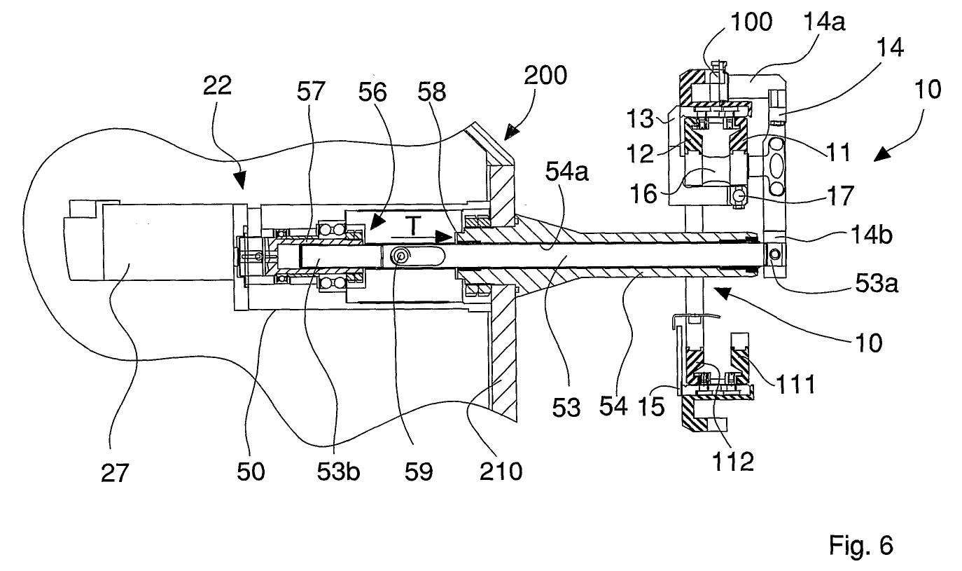

FIG. 6 is a partial cross-section according to a plane VI-VI of FIG. 1;

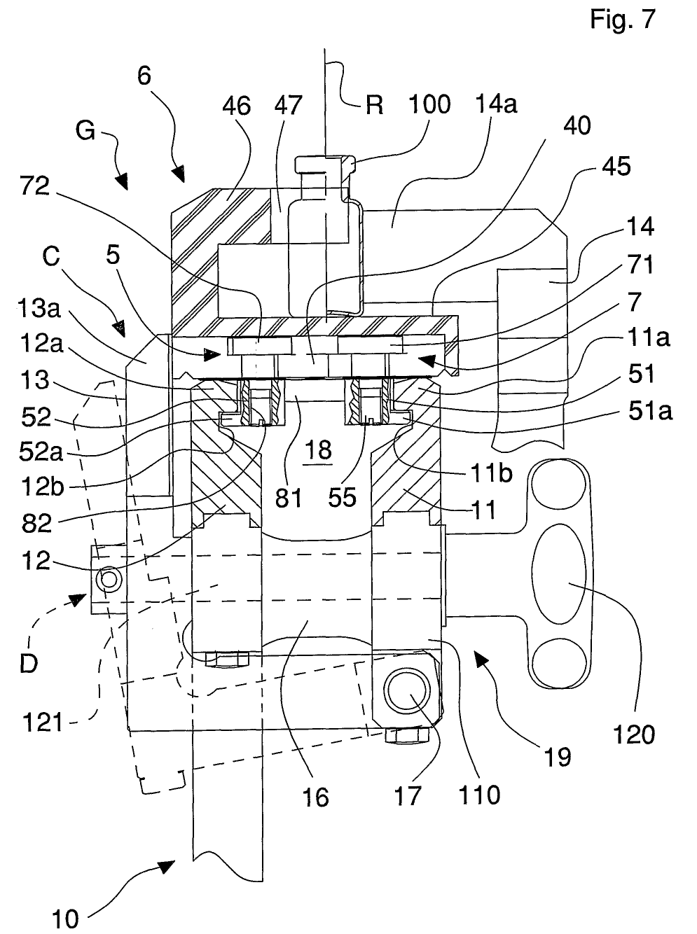

FIG. 7 is an enlarged partial view of a detail of FIG. 3, showing a supporting element in association with a container;

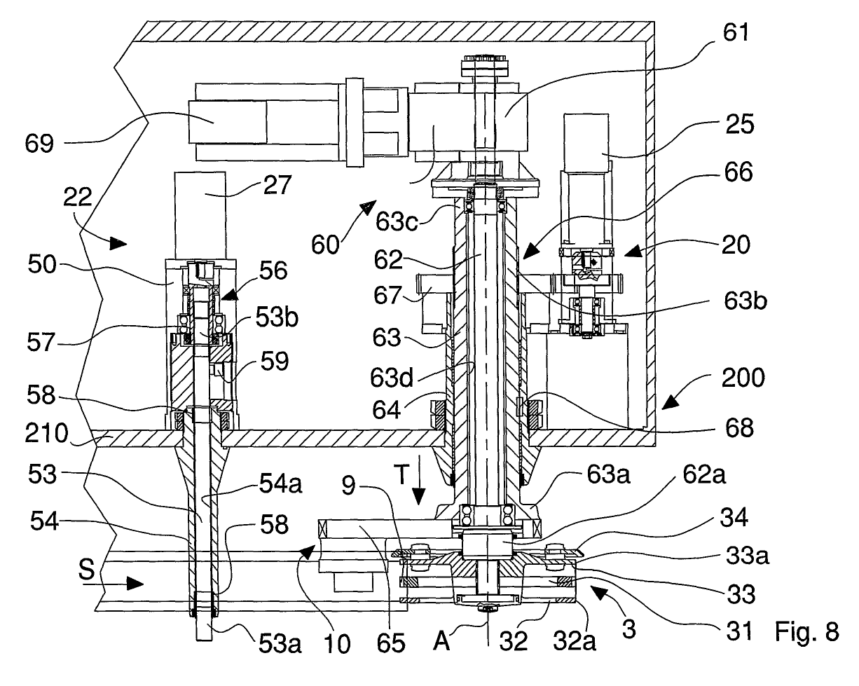

FIG. 8 is a partial cross-section according to a plane VIII-VIII of FIG. 1;

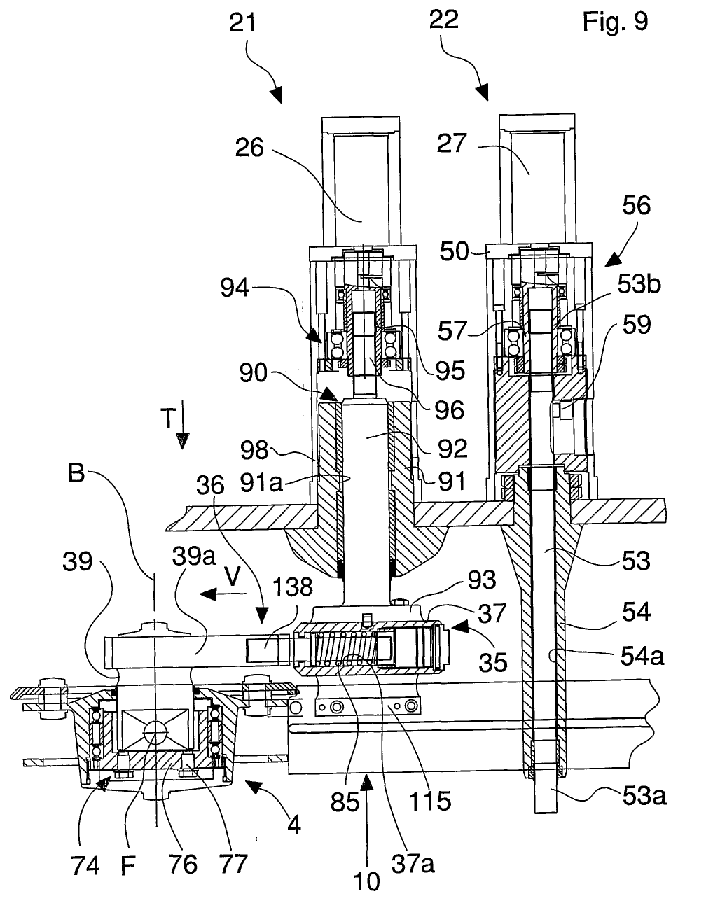

FIG. 9 is a partial cross-section according to a plane IX-IX of FIG. 1;

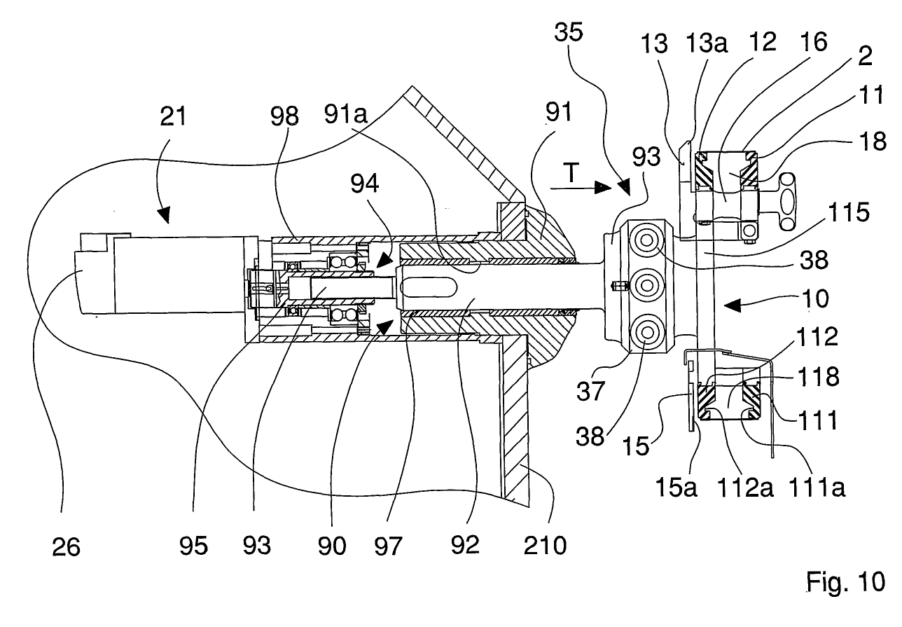

FIG. 10 is a partial cross-section according to a plane X-X of FIG. 1;

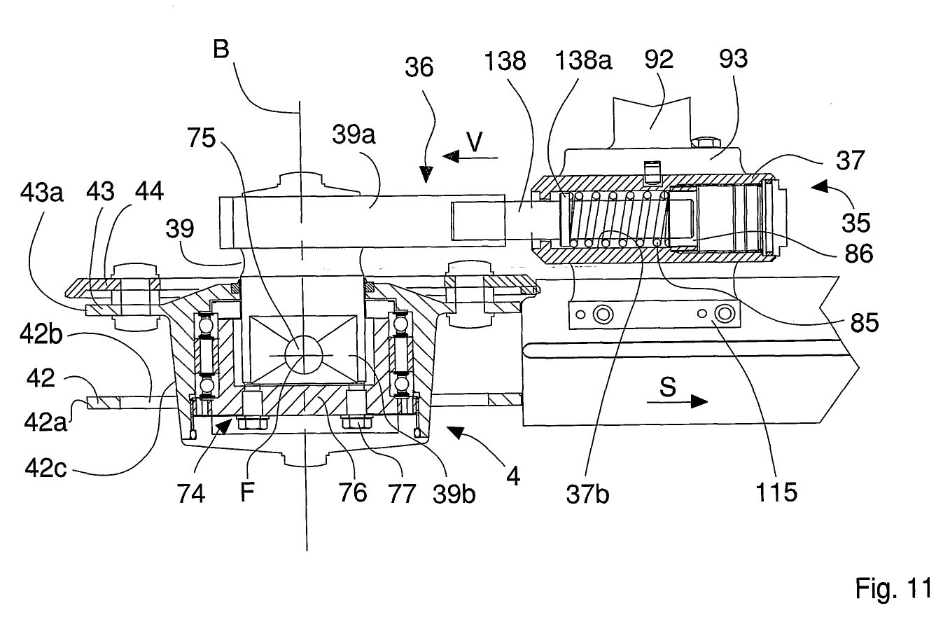

FIG. 11 is an enlarged partial view of a detail of FIG. 3, showing a driven pulley and a tensioning arrangement associated with it.

With reference to FIGS. 1 to 10, a conveyor apparatus 1 for containers 100 is shown, comprising a belt 2, closed in a loop around a pulley arrangement 3, 4 configured for driving said belt 2 along a longitudinal direction of advancement S. The belt 2 is made of inextensible metallic material and typically consists of a stainless steel belt, flat and smooth, suitable for packaging pharmaceutical products in aseptic and sterile environment.

Apparatus 1 further comprises supporting elements 6, so-called “godet”, configured for receiving and housing the containers 100 and removably associated with metal belt 2, in a hooking condition G, by means of connecting elements 5 fixed equidistant from one another to said belt 2.

Each connecting element 5 comprises a coupling arrangement 7 which allows removable coupling of a respective supporting element 6 and a driving arrangement 8, intended for engaging in a holding arrangement 9 made in pulley arrangement 3, 4. The reciprocal engagement or meshing between the driving arrangement 8 and the holding arrangement 9, at least partially, drives metal belt 2 following rotation of pulley arrangement 3, 4 and ensures the step ratio between said pulley arrangement 3, 4 and said belt 2, preventing relative slipping and sliding of the latter.

The pulley arrangement 3, 4 comprises a drive pulley 3 rotating around a first rotation axis A and a driven pulley 4, idling around a second rotation axis B. The rotation axes A, B are parallel to one another and substantially orthogonal to the direction of sliding S of belt 2.

Rotation axes A, B are further substantially orthogonal to a vertical reference plane R along which the containers 100 are moved and in relation to which the operating stations of a packaging machine 200, with which the conveyor apparatus can be associated must be aligned.

The holding arrangement 9 is made on an outer circumferential edge of said drive pulley 3, equidistant with step equal to the step between two adjacent connecting elements 5 fixed to metal belt 2 (FIG. 2).

In an embodiment of the apparatus that is not shown, the holding arrangement 9 is present also on a respective outer circumferential edge of driven pulley 4.

The coupling arrangement 7 and the driving arrangement 8 of each connecting element 5 are associated with an outer surface 2a and an inner surface 2b, respectively, of metal belt 2.

The coupling arrangement 7 includes one or more shaped elements 71, 72, configured to engage a seat 40 made in a corresponding supporting element 6. With reference to FIGS. 3 and 7, the coupling arrangement 7 may include, for example, a pair of shaped pins 71, 72 with flat heads for engaging slidably in seat 40 of supporting element 6, in this particular case consisting of a longitudinal groove, with a “T” shaped cross-section.

Conveyor apparatus 1 comprises a frame 10 configured for supporting and guiding the belt 2 in its movements. In particular, the frame 10 supports a first contrast element 13, provided for abutting and maintaining supporting elements 6 in coupling condition G, preventing them from slipping off and getting unhooked from coupling arrangement 7 of the respective connecting elements 5 (FIGS. 8 and 10).

The first contrast element 13 is movable between a blocking position C, where it abuts and blocks supporting elements 6 in condition G, and a release position D, wherein it is at a distance from said supporting elements 6 to allow removal from belt 2 (FIG. 7).

The first contrast element 13 is positioned at an upper or conveying branch of belt 2, i.e. the branch which conveys the supporting elements 6 provided with containers 100.

The first contrast element 13 is, for example, hinged by means of fulcrums 17 to connecting portions 110 of said frame 10, so as to be able to rotate between said blocking position C and said release position D, and the other way around.

In an embodiment that is not shown, the first contrast element 13 is slidably fixed to frame 10 so as to move between said blocking position C and release position D.

A manual driving device 19 is provided, consisting, for example, of a knob 120 for moving a threaded rod 121, fixed to said first contrast element 13 for rotating the latter between the blocking C and release D positions.

Apparatus 1 comprising also a second contrast element 15 removably fixed to frame 10 and configured for abutting and maintaining supporting elements 6 in coupling condition G at the lower or return branch of belt 2.

The first contrast element 13 and the second contrast element 15 comprise respective friction portions 13a, 15°, respectively, made up of one or more straight rods, intended for making contact with the supporting elements 6.

In an embodiment of the apparatus that is not shown, these friction portions are replaced by a plurality of idle rollers, rotatably supporting by said contrast elements 13, 15 and intended for abutting said supporting elements 6.

The driving arrangement 8 of each connecting element 5 comprises a protrusion 81 provided for engaging in holding arrangement 9 which consist of a series of cavities obtained in drive pulley 3 and having a shape complementary to said protrusion.

The protrusions 81 act as driving teeth for meshing with the corresponding cavities 9 of drive pulley 3.

The protrusion 81 and the corresponding cavity 9 comprise portions of complementary surfaces, concave and convex, respectively, for example, a cylindrical or spherical surface.

The protrusion 81 may also be shaped like a straight tooth with sides having profile matching that of the walls of each cavity 9, similar to that in toothed wheels. In an embodiment of apparatus 1 that is not shown, the driving arrangement 8 of each connecting element 5 comprises a cavity or compartment, intended for being engaged by holding arrangement 9 of drive pulley 3 consisting of protrusions having complementary shape.

These cavities and protrusions obviously have the same shapes and features of protrusion 81 and relative cavity 9 of drive wheel 3.

The working of said embodiment of apparatus 1 is identical to that of the sort of structure disclosed above.

The coupling between the driving arrangement 8 and the holding arrangement 9 ensures a correct step reference between the belt 2 and the drive pulley 3 during the working, since it prevents relative slipping and sliding between the latter. This is obtained also owing to the shape of the protrusions and cavities, which allows correct meshing at each step, so that a phase displacement, if any, due to a difference in step between two consecutive protrusions and two consecutive cavities is recovered by automatic “centring” of each protrusion inside its cavity. In fact, it is noticed that, if a protrusion inserts itself in its respective cavity with a difference, as compared to the exact position required, its shape will allow automatic adaptation to the cavity, i.e. a correct repositioning inside the latter.

The coupling arrangement 7 and the driving arrangement 8 are removably interconnected by means of a known type of fixing elements 55 such as screws or threaded grub screws which may be separate and distinct from said coupling arrangement 7 or integrated with these. In this case, the shaped pins 71, 72 may comprise threaded shanks 55 intended for engaging in respective threaded seats 82 of driving arrangement 8 (FIG. 7).

Belt 2 comprises a plurality of openings 2c equidistant along the length of said belt, which make it possible to fix the connecting elements 5 to said belt 2. In particular, the openings 2c allow connection between the coupling arrangement 7 and the corresponding driving arrangement 8, i.e. the passage of fixing elements 55 (FIG. 3).

Once fixed to belt 2, the coupling arrangement 7 and the driving arrangement 8, connected to one another, completely occlude these openings 2c thereby preventing the passage and, spreading of substances or products that may have been accidentally spilt or spread on the outer surface 2a on the inner surface 2b. For this purpose, a sealing gasket 78 may be provided, such as an “O-ring”, which is placed between the shaped pin 71, 72 and the inner surface 2a of belt 2 to prevent passage of liquid substances or products through opening 2c. In such cases, shaped pin 71, 72 is provided with a seat for receiving gasket 78 (FIG. 4). The connecting elements 5 can also be washed and sterilized whether assembled in place on belt 2, for example by means of sterilization procedures using hydrogen peroxide, or after dismantling them from said belt.

Each supporting element 6 comprises a resting portion 45 for one or more containers 100 and supporting portions 46 suitable for supporting the latter laterally to hold them erect. The supporting portions 46 form divergent walls of an open housing 47, which is more or less triangular or V-shaped in plane view, for receiving containers of different shapes (FIG. 3).

Alternatively, housing 47 has a semicircular shape for receiving only one container shape.

Supporting element 6 shown in the Figures is capable of receiving a pair of containers 100 side by side. It may, however, be made for supporting two or more containers or a single container.

A third contrast element 14 can be provided for supporting and maintaining containers 100 stable in their respective housings 47, especially during their movement.

In particular, the third contrast element 14 transversely abuts containers 100 with respect to the longitudinal sliding direction S, with a respective friction portion 14a. The frame 10 comprises a guiding arrangement 11, 12, 111, 112 provided for supporting and guiding belt 2. The guiding arrangement comprises first longitudinal guides 11, 12, consisting of a pair of straight slats or bars, at a distance from one another and parallel to the direction of advancement S and interconnected by a plurality of connecting crosspieces 16.

Said first longitudinal guides 11, 12 abut the inner surface 2b of said belt 2 by means of respective friction portions 11a, 12a, at their upper branch, and form a respective elongated channel or cavity 18.

The guiding arrangement further comprises second longitudinal guides 111, 112 entirely similar to first longitudinal guides 11, 12 but intended for abutting the inner surface 2b of said belt 2 by means of respective friction portions, at the lower or return branch of the latter.

The second longitudinal guides 111, 112 form a respective elongated cavity 118. Each connecting element 5 comprises a reference arrangement 51, 52 configured for engaging in said elongated cavities 18, 118 and abutting the guiding arrangement 11, 12, 111, 112 in order to prevent belt 2 from shifting in the transverse direction.

Said reference arrangement 51, 52 substantially comprises a pair of prismatic elements associated with inner surface 2b of belt 2 and situated on opposite sides of driving protrusion 8.

The driving arrangement 8 and the reference arrangement 51, 52 are made in a single body and form a single element comprising a central portion, which forms the protrusion 81 for the holding arrangement 9, and lateral portions which constitute the reference arrangement 51, 52.

In this configuration, the threaded seats 82 of driving arrangement 8 for the fixing elements 55 are made in said lateral portions 51, 52.

In an embodiment that is not shown, the reference arrangement 51, 52 may be distinct and connected to driving arrangement 8 or coupling arrangement 7.

The reference arrangement 51, 52 further comprise respective anchoring portions or tailpieces 51a, 52a for engaging in corresponding longitudinal straight grooves 11b, 12b, 111b, 112b made in the respective guiding arrangement 11, 12, 111, 112.

Insertion of said tailpieces 51a, 52a in grooves prevents detachment of connecting elements 5, and thereby of belt 2, from guiding arrangement 11, 12, 111, 112.

The longitudinal guides 11, 12, 111, 112, reference arrangement 51, 52 connecting elements 5 and at least the friction portions 13a, 14a, 15a of contrast elements 13, 14, 15 are made of material having low friction coefficient, good resistance to wear and high resistance to chemical agents, for example, a thermoplastic material with high specific weight, such as polyethylene.

In order to allow apparatus 1 to convey containers 100 of different sizes, the pulley arrangement 3, 4, the frame 10 and the third contrast element 14 are movable and adjustable in position along a transverse direction of adjustment T more or less orthogonal to the longitudinal direction of advancement S and to the vertical reference plane R.

The direction of adjustment T is also parallel to the rotation axes A, B of pulleys 3, 4.

This adjustment must be made in order to maintain the containers 100 aligned to the vertical reference plane R irrespective of their dimensions and/or shapes. Apparatus 1 comprises a first positioning arrangement 20 and a second positioning arrangement 21 configured for moving the pulley arrangement 3, 4 and the frame 10 along said direction of adjustment T.

Apparatus 1 also comprises an adjusting arrangement 22 suitable for moving the third contrast element 14 for adjusting the position along the direction of adjustment T.

With reference to FIG. 8, the first positioning arrangement 20 is capable of moving a first movable supporting element 63 of drive pulley 3 and frame 10.

The first movable supporting element 63 is, in fact, slidably supported by a first fixed supporting element 64 of apparatus 1, connected to a fixed frame 210 of packaging machine 200.

The first movable supporting element 63 may comprise, for example, an elongated sleeve provided at one end of a respective hub 63a, for rotatably supporting said drive pulley 3 and a supporting lever 65, which supports the frame 10.

The first positioning arrangement 20 comprises a first actuating device 25 of the rotating type, for example, electric brushless motors, connected to said first movable supporting element 63 by means of a first transmission arrangement 66, comprising, for example, a screw drive system coupling arrangement.

In particular, the first actuating device 25 drives a leadscrew 67 which engages with a threaded portion 63b of movable supporting element 63 bringing about translation, because the rotation of said first movable supporting element 63 is blocked by antirotation elements 68, for example, one or more stop pins.

Alternatively, the first actuating device 25 may be of the linear type, and be connected directly to said first movable supporting element 63.

With reference to FIG. 9, the second positioning arrangement 21 is capable of moving a second movable supporting element 90 provided for supporting the driven pulley 4 and the frame 10 along said direction of adjustment T.

The second movable supporting element 90 is, in fact, slidably supported by a second fixed supporting element 91 of apparatus 1, connected to fixed frame 210 of packaging machine 200.

The second movable supporting element 90 comprises a sliding pin 92, slidably inserted inside second fixed supporting element 91, and an attaching element 93 fixed to one end of said sliding pin 92 and suitable for supporting said frame 10 and said idle pulley 4. In particular, a supporting plate 115 of said frame 10 is fixed to attaching element 93.

The second fixed supporting element 91 comprises a respective sleeve provided with cylindrical hole 91a for housing the sliding pin 92, with suitable plain bushes placed in between.

The second positioning arrangement 21 comprises a second actuating device 26 of the rotating type, for example, electric brushless motors, connected to said second movable supporting element 90 by means of a second transmission arrangement 94, comprising, for example, a screw drive system coupling arrangement.

In particular, said second actuating device 26 drives a second leadscrew 95, consisting of a tube threaded internally, which engages with a threaded shank 96 fixed coaxially to the end of sliding pin 92 and opposite to attaching element 93. Since the second movable supporting element 90 cannot rotate as it is fixed to frame 10 and to driven pulley 3, the rotation of the second leadscrew 95 determines the movement of second movable supporting element 90 in the direction of adjustment T.

Alternatively, the second actuating device 26 may be of the linear type, and be connected directly to said second movable supporting element 90.

A fixing element 98 makes it possible to connect the first screw drive system coupling arrangement 94 and the second actuating device 26 to fixed frame 210. An interconnecting device is provided which is capable of interconnecting said positioning arrangements 20, 21 and allow these to move simultaneously to the same extent in the same direction of adjustment T. The interconnecting device is of the electronic type and comprises, for example, an electronic device for handling and control of actuating devices 25, 26.

In an embodiment of the apparatus of the invention (not shown), the interconnecting device is of the mechanical type, for example belt and/or gear mechanisms, driven only by first actuating device 25 or only by second actuating device 26.

The third positioning arrangement 22 of the third contrast element 14 is capable of moving a third movable supporting element 53 with which said third contrast element 14 is fixed.

Said third movable supporting element 53 comprises a supporting shaft slidably supported by a third fixed supporting element 54 of apparatus 1 and a connection end 53a to which a supporting frame 14b of said third contrast element 14 is connected.

The third fixed supporting element 54 is connected rigidly to fixed frame 210 of packaging machine 200 and comprises a spindle provided with a cylindrical seat 54a suitable for housing the supporting shaft 53, by interposing suitable plain bushes.

The third positioning arrangement 22 comprises a third actuating device 27 of the rotating type, for example, electric brushless motors, connected to said third movable supporting element 53 by means of a third transmission arrangement 56, comprising, for example, a screw drive system coupling arrangement.

The third actuating device 27 drives a third leadscrew 57 which engages with a threaded end 53b, opposite connecting end 53a, of supporting shaft 53 determining the movement, since the latter is prevented from rotating by respective antirotation elements 59.

Alternatively, the third actuating device 27 may be of the linear type, and be connected directly to third movable supporting element 53.

The third positioning arrangement 22 further includes an attaching element 50 which makes it possible to support and fix the third screw drive system coupling arrangement 56 and the third actuating device 27 to fixed frame 210.

Apparatus 1 comprises a pair of a third positioning arrangement 22, placed between the drive pulley 3 and the driven pulley 4.

The third positioning arrangement 22 may, however, be more than two, for example, if the belt 2 is particularly long and/or large sized containers 100 are to be conveyed.

Apparatus 1 comprises a further interconnecting device capable of connecting the pair of third positioning arrangement 22. The further interconnecting device is of the electronic type and comprises, for example, a respective electronic device for handling and control of third actuating device 27.

In an embodiment of the apparatus that is not shown, the interconnecting device is of the mechanical type driven by third actuating device 27 of one of the third positioning arrangement 22.

The positioning arrangement 20, 21, 22, make it possible to automatically move pulley arrangement 3, 4, the frame 10 and the third abutting element 14 along said direction of adjustment T and thereby make it possible to carry out rapid, easy and precise size change operations without manual intervention by operators.

These operations can, in fact, be carried out by the machine's control and handling device, in which it is possible to enter and save in memory the operating data and parameters associated with each container size transportable by the apparatus. The possibility of carrying out size change without manual intervention by operators is particularly advantageous in applications in the pharmaceutical field, in which the conveyor apparatus is inserted in a production process in an aseptic or sterile environment, in which manual human intervention must be reduced to the minimum to avoid contamination.

Apparatus 1 further comprises a moving arrangement 60 provided for rotating drive pulley 3 around first rotation axis A and suitably fixed to said drive pulley 3 so as to be movable with it along the direction of adjustment T.

The moving arrangement 60 comprises a motor 69, consisting of a rotating brushless electric motor, which rotates a drive shaft 62 on a free end 62a to which drive pulley 3 is fixed.

The connection between motor 69 and drive shaft 62 may be direct or indirect by interposing a suitable fourth motion transmission arrangement 61, consisting of a speed reducer and/or right angle gear.

The motor 69 and the fourth transmission arrangement 61 are fixed to an end 63c of first movable supporting element 63 opposite hub 63a.

The first movable supporting element 63 has a coaxial hole 63d for the passage and rotatable support of drive shaft 62 by means of suitable roller bearings.

In this way, the assembly consisting of the motor 69, fourth transmission arrangement 61, drive shaft 62 and drive pulley 3 is entirely supported by first movable supporting element 63, which is movable inside first fixed supporting element 64, as disclosed earlier.

This solution, in which the motor 69 is en bloc and moves with the drive shaft 62 and the drive pulley 3, avoids the use of slidable joints or couplings, such as grooved profiles, to bring about simultaneous movement and rotation of the shaft. This makes it possible to simplify the structure of moving arrangement 60 and first positioning arrangement 20 and, at the same time, makes it possible to eliminate plays and inaccuracies in the transmission of rotation, which such slidable joints or couplings could introduce.

An angular offset between the shaft of motor 69 and drive shaft 62 of drive pulley 3 would, in fact, result in a linear offset of the belt 2, i.e. an inaccurate and incorrect positioning of containers 100 at the operating stations of packaging machine 200, during the working.

Conveyor apparatus 1 comprises a tensioning arrangement 35 suitable for changing the centre distance between the drive pulley 3 and the driven pulley 4 in order to adjust the tension of belt 2. A correct tension is essential for giving belt 2 the necessary rigidity and to ensure the containers 100 move along a more or less plane and horizontal trajectory.

The tensioning arrangement 35 comprises a first supporting element 37, fixed to attaching element 93 of second positioning arrangement 21, and a second supporting element 36 which support the driven pulley 4 and are slidably supported by said supporting element 37.

The second supporting element 36 is movable axially along a longitudinal direction of tensioning V, more or less parallel to the direction of advancement S and orthogonal to the second axis of rotation B of driven pulley 4.

The second supporting element 36 comprises one or more guiding rods 38 parallel and spaced, for example two, arranged on a plane parallel to vertical reference plane R and fixed to a supporting pin 39 of driven pulley 4. Each rod 38 shows one end inserted slidably inside a respective seat 37a of first supporting element 37, and the other end fixed to a coupling portion 39a of said supporting pin 39, for example, shaped like a plate.

The supporting pin 39 also has a hub portion 39b suitable for rotatably supporting the driven pulley 4.

A pusher rod 138 is provided, interposed between the two guiding rods 38, also fixed to coupling portion 39a and slidable inside a respective seat 37b of first supporting element 37. Inside said seat 37b, a pushing element 85 is provided, suitable for exerting a predefined tensioning force or push on corresponding pusher rod 138.

Said pushing element 85 is, for example, of the elastic type and consists of one or more cylindrical helical springs which act in compression on an abutment 138a of said pusher rod 138, in such a way as to push the latter out of first supporting element 37. The pusher rod 138 thus acts in the direction of tensioning V in such a way as to move the second rotation axis B of driven pulley 4 away from first supporting element 37, and thereby place belt 2 in tension with said predefined force.

A first adjusting arrangement 86 is provided suitable for adjusting the degree of compression of elastic pushing element 85 and the intensity of the tensioning force.

The first adjusting arrangement 86 comprises a ring nut engaged in a threading made in seat 37a in which the pushing element 85 is inserted. The latter can be preloaded by acting manually on the ring nut.

In a variation of conveyor apparatus 1 that is not shown, the pushing element 85 comprises a pneumatic or electric linear actuator which acts directly on pusher rod 138. In this case, the first adjusting arrangement 86 comprises parts for adjusting the pressure and/or flow rate of compressed air or electricity.

Conveyor apparatus 1 further comprises an angular adjusting arrangement 74 suitable for adjusting the angular position of the driven pulley 4 in relation to an adjustment axis F more or less orthogonal and incident to second rotation axis B of driven pulley 3. Said adjusting axis F is also orthogonal to the direction of advancement S.

The angular adjusting arrangement 74 comprises an oscillating pin 75 fixed to hub portion 39b of supporting pin 39. The longitudinal axis of rotating pin 75 coincides with the regulation axis F.

The rotating pin 75 rotatably supports an internal bushing 76 to which the driven pulley 4 is idly splined with suitable bushings interposed in between. The internal bushing 76 can therefore rotate around the adjustment axis F and its angular position, and therefore that of the driven pulley 4, in relation to supporting pin 39 is defined and fixed using a second adjusting arrangement 77 of angular adjustment arrangement 74.

With specific reference to FIG. 11, the second adjusting arrangement 77 comprises two or more threaded elements, for example micrometer screws, screwed in respective through holes obtained in a bottom wall of internal bushing 76 and arranged for abutting with respective shanks a front surface of hub portion 39b in supporting pin 39. By acting on said adjuster screws 77 it is possible to modify the angular position of the internal bushing 76 in relation to hub portion 39b.

According to an embodiment of the apparatus that is not shown, the angular adjusting arrangement 74 must be arranged for adjusting the angular position of drive pulley 3 in relation to a respective adjustment axis more or less orthogonal and incident to first rotation axis A of said pulley 4.

In a further embodiment of the apparatus, the angular adjusting arrangement 74 are configured for adjusting the angular position of both pulley 3, 4.

With reference to FIGS. 5 and 8, the drive pulley 3 comprises a central disk 31 and two side disks 32, 33, said disks 31, 32 and 33 being spaced at equal distances and coaxial to the first rotation axis of drive pulley 3.

The central disk 31 has a respective outer circumferential edge 31a carrying the holding arrangement 9, consisting of a plurality of angularly equidistant hollows. Each hollow is open on the side and consists of a cylindrical surface portion with generating lines parallel to first rotation axis A of drive pulley 3.

The two side disks 32, 33 are arranged on the opposite sides of the central disk 31 and have respective peripheral edges 32a, 33a meant for abutting and supporting the belt 2.

The side disks 32, 33 contribute to driving belt 2 by friction, while the central disk 31 in virtue of hollows 9 prevents possible relative slipping and sliding of belt 2 during the movement.

With reference to FIG. 11, the driven pulley 4 comprises two outer disks 42, 43 provided with respective peripheral edges 42a, 43a suitable for abutting and supporting belt 2. The outer disks 42, 43 and spaced from one another and coaxial to the second rotation axis B of driven pulley 4.

These outer disks 42, 43 can be made in a single body.

In order to ensure correct drainage of a washing liquid during the apparatus 1 cleaning operations, in drive pulley 3, disks 31, 32, 33 form a conical hub with the respective portions 31c, 32c, 33c and have passage openings 31b, 32b. Similarly, in driven pulley 4 the outer disks 42, 43 form a conical hub 42c and have passage openings 42b to allow drainage of the washing liquid.

The drive pulley 3 and the driven pulley 4 comprise a first contrast disk 34 and a second contrast disk 44, respectively, suitable for abutting the containment elements 6 and maintaining them in the coupled condition G.

1.-212. (canceled)

213. Apparatus for conveying containers comprising a belt, moved by a pulley arrangement along a longitudinal direction of advancement, and supporting elements of said containers associable with said belt by means of connecting elements fixed to said belt, wherein each connecting element comprises a coupling arrangement for engaging and blocking a respective supporting element and a driving arrangement, suitable for engaging a holding arrangement of said pulley arrangement for moving said belt.

214. Apparatus according to claim 213, wherein said coupling arrangement of said connecting element comprises at least one shaped element suitable for engaging a seat of a respective supporting element.

215. Apparatus according to claim 213, wherein said driving arrangement of said connecting element comprises a protrusion, and said holding arrangement comprises cavities having a shape complementary to said protrusion.

216. Apparatus according to claim 213, wherein said driving arrangement of said connecting element comprises a cavity and said holding arrangement comprises protrusions having a shape complementary to said cavity.

217. Apparatus according to claim 215, wherein said cavities and said protrusion comprise concave and convex portions, respectively, of cylindrical or spherical surfaces.

218. Apparatus according to claim 216, wherein said cavity and said protrusions comprise concave and convex portions, respectively, of cylindrical or spherical surfaces.

219. Apparatus according to claim 213, wherein said coupling arrangement and said driving arrangement are associated with an external surface and an internal surface of said belt, respectively.

220. Apparatus according to claim 219, wherein said coupling arrangement and said driving arrangement are removably connected to each other and to said belt by a fixing element.

221. Apparatus according to claim 213, comprising a frame provided with a guiding arrangement for supporting and guiding said belt.

222. Apparatus according to claim 213, comprising a first contrast element and a second contrast element suitable for abutting and maintaining said supporting elements connected to respective connecting elements in a coupling condition, and a third contrast element suitable for abutting and maintaining said containers in respective supporting elements.

223. Apparatus according to claim 222, comprising a frame provided with a guiding arrangement for supporting and guiding said belt wherein said pulley arrangement, said frame and said third contrast element are movable along a transverse direction of adjustment, more or less orthogonal to said direction of advancement.

224. Apparatus according to claim 213, wherein said pulley arrangement comprises a drive pulley rotating around a first rotation axis and a driven pulley rotating around a second rotation axis more or less parallel to said first rotation axis.

225. Apparatus according to claims 224, comprising a moving arrangement suitable for driving said pulley arrangement in rotation, said moving arrangement being connected to said drive pulley and movable with the latter along said direction of adjustment.

226. Apparatus according to claim 223, comprising a first positioning arrangement and a second positioning arrangement for supporting and moving said pulley arrangement and said frame in such a way as to adjust the position along said direction of adjustment.

227. Apparatus according to claim 223, comprising a third positioning arrangement suitable for moving said third contrast element for adjusting the position along said direction of adjustment.

228. Apparatus according to claim 224, comprising a tensioning arrangement suitable for changing the distance between said drive pulley and said driven pulley along said direction of advancement to adjust the tension of said belt.

229. Apparatus according to claim 224, wherein said drive pulley comprises a central disk, provided with an outer edge carrying said holding arrangement, and two lateral disks placed on opposite sides of said central disk and provided with respective peripheral edges for abutting and supporting said belt.

230. Apparatus according to claim 224, wherein said driven pulley comprises two outer disks provided with respective peripheral edges for abutting and supporting said belt.

231. Apparatus according to claim 224, wherein said drive pulley and said driven pulley comprise respective contrast disks suitable for abutting and maintaining said supporting elements in said coupling condition.

232. Packaging machine comprising an apparatus for conveying containers according to claim 213.
